(19) United States
(12) Patent Application Publication
(10) Pub. No.: US 2026/0010742 A1
(43) Pub. Date: Jan. 8, 2026

(54) ADDRESSING A SINGLE AMBIENT INTERNET OF THINGS DEVICE

(71) Applicant: QUALCOMM Incorporated, San Diego, CA (US)

(72) Inventor: Ahmed Abdelaziz Ibrahim Abdelaziz ZEWAIL, San Diego, CA (US)

(21) Appl. No.: 18/761,620

(22) Filed: Jul. 2, 2024

(51) Int. Cl. G06K 7/10; H04B 17/20; H04B 17/318; H04B 17/391

(52) U.S. Cl. CPC G06K 7/10217; H04B 17/202; H04B 17/318; H04B 17/3912

(57) ABSTRACT

Wireless communications systems, apparatuses, and methods are provided. A method of wireless communication performed by an ambient Internet of Things (IoT) devices may include receiving, from a first wireless communication device, a first signal. The ambient IoT device may be powered by energy transmitted by the first wireless communication device. The method may further include selecting, based on at least one of an energy conversion efficiency associated with the first signal or a communication link quality associated with the first wireless communication device, a second wireless communication device, and receiving, from the second wireless communication device, a second signal.

### TECHNICAL FIELD

This application relates to wireless communication systems, and more particularly, to improving wireless communications between ambient Internet of Things (IoT) devices and other wireless communication devices, especially communicating with or determining the closest ambient IoT device to the IoT reader.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power).

Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be passive IoT devices. Passive IoT devices may include radio frequency identification (RFID) tags or sensors. User equipment (UE) devices may communicate with passive IoT devices. A UE may be, for example, an RFID reader device. In some scenarios, it may be desirable to determine the closest IoT device to a reader device, or otherwise communicate with only a single IoT device.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a wireless communication device comprises one or more memories and one or more processors coupled to the one or more memories, the one or more memories storing instructions that are executable by the one or more processors, configured individually or in any combination, to cause the wireless communication device to broadcast, to a plurality of devices, a first signal indicating a first threshold value; receive, from two or more of the plurality of devices, respective first responses to the first signal; broadcast, to at least one of the plurality of devices based on receiving more than one respective first responses, a second signal indicating a second threshold value higher than the first threshold value; and receive, from one of the plurality of devices, a second response to the second signal, the second response identifying the one of the plurality of devices.

In an additional aspect of the disclosure, a method of wireless communication performed by a wireless communication device comprises broadcasting, to a plurality of devices, a first signal indicating a first threshold value; receiving, from two or more of the plurality of devices, respective first responses to the first signal; broadcasting, to at least one of the plurality of devices based on receiving more than one respective first responses, a second signal indicating a second threshold value higher than the first threshold value; and receiving, from one of the plurality of devices, a second response to the second signal, the second response identifying the one of the plurality of devices.

In an additional aspect of the disclosure, a non-transitory computer-readable medium has program code recorded thereon for wireless communication by a wireless communication device, the program code comprising code for causing the wireless communication device to broadcast, to a plurality of devices, a first signal indicating a first threshold value; code for causing the wireless communication device to receive, from two or more of the plurality of devices, respective first responses to the first signal; code for causing the wireless communication device to broadcast, to at least one of the plurality of devices based on receiving more than one respective first responses, a second signal indicating a second threshold value higher than the first threshold value; and code for causing the wireless communication device to receive, from one of the plurality of devices, a second response to the second signal, the second response identifying the one of the plurality of devices.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention may include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances may be implemented in various devices, systems, and methods.

### BRIEF DESCRIPTION OF THE DRAWINGS

FIG. 1 illustrates an example wireless communication network according to some aspects of the present disclosure.

FIG. 2 illustrates an example disaggregated base station architecture according to some aspects of the present disclosure.

FIG. 3 illustrates an example wireless communication between a UE and ambient IoT devices according to some aspects of the present disclosure.

FIG. 4 is a signal flow diagram of an exemplary communication method according to some aspects of the present disclosure.

FIG. 5 is a block diagram of an exemplary ambient IoT device according to some aspects of the present disclosure.

FIG. 6 is a block diagram of an exemplary IoT reader according to some aspects of the present disclosure.

FIG. 7 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

RFID is a rapidly growing technology in many industries because RFID technologies provide high economic potential in the fields of asset management, IoT, sustainable sensor networks, smart home, and the like. RFID may include small transponders emitting an information-bearing signal upon receiving a signal, such that RFID is able to be operated without a battery at low operating expense. As 5G is expanding to more industrial verticals besides eMBB, e.g., URLLC and MTC, 5G and beyond may be expanded to support passive IoT. A backscatter-based device (e.g., a passive ambient IoT device) may be powered by a base station (BS), user equipment (UE) or other IoT device reader, and communicate responses to the transmitting wireless communication device. In some aspects, a reader (e.g., a UE) broadcasts a signal to a number of IoT devices. The contents of the signal may include a threshold value. The IoT devices may be configured to only transmit a response to the broadcast if the measured power of the broadcast signal exceeds (or otherwise satisfies) the indicated threshold value. If multiple responses are received to a broadcast, the reader may adjust the threshold value and broadcast another signal with the adjusted threshold value. The IoT devices that satisfy the updated threshold may transmit responses to the second broadcast. The process may repeat until one IoT device, or some predetermined number, responds. Based on the response, the reader may identify a single IoT device, which may represent the closest device to the reader.

Particular aspects of the subject matter described in this disclosure may be implemented to realize one or more of the following potential advantages. In some examples, a handheld reader may be used to identify a specific device without having to directly scan some surface feature (e.g., a QR code), but by only being in the near vicinity of the device. For example, to identify a box in a warehouse, the reader may only need to be located proximate to the box, and may identify it even when other IoT devices are in the vicinity and would otherwise respond to a broadcast. This allows for low power simple IoT devices to be used while providing the necessary performance, thereby reducing the cost and power of existing location systems. By limiting subsequent communication to only the nearest device, computation complexity may be reduced without the need to communicate with many IoT devices at once.

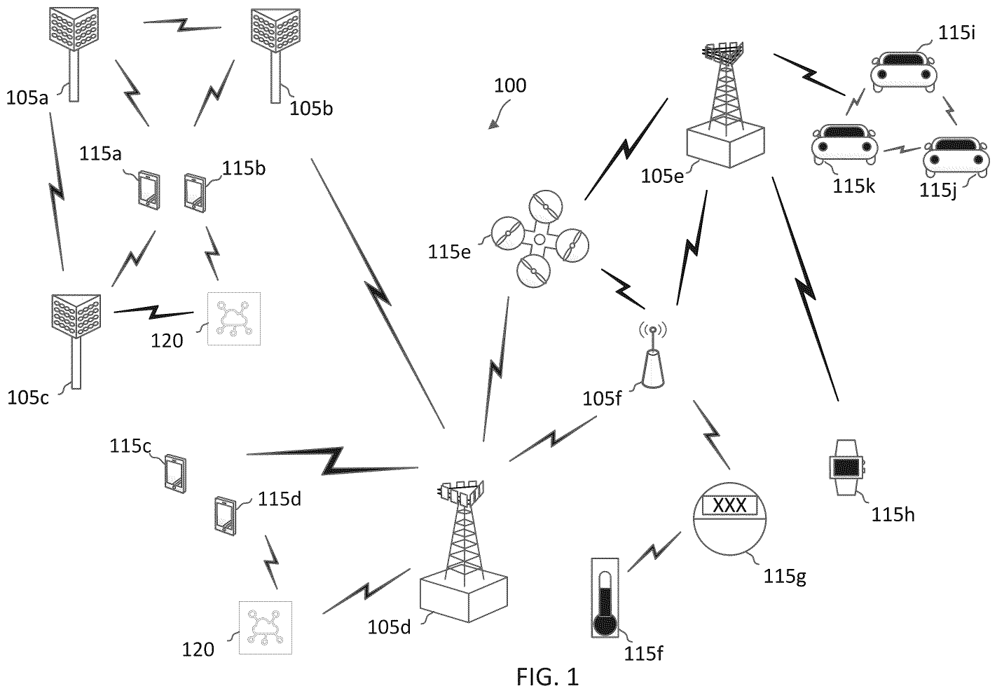

FIG. 1 illustrates a wireless communication network 100, according to some aspects of the present disclosure. The network 100 includes a number of base stations (BSs) 105 and other network entities. In some aspects, a BS 105 may be interchangeable with a network node, and not limited to base stations. A BS 105 may be a station that communicates with UEs 115 and/or an internet of things (IoT) device 120 and may also be referred to as an evolved node B (eNB), a next generation eNB (gNB), an access point, and the like. Each BS 105 may provide communication coverage for a particular geographic area. In 3GPP, the term “cell” may refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 and/or IoT devices 120 may be dispersed throughout the wireless network 100, and each UE 115 and/or IoT device 120 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, a handheld RFID reader, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices 120 or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The IoT devices 120 may include one or more sensors and be configured for communication with a BS 105 and/or a UE 115. In some aspects, the IoT device 120 may be powered by energy transmitted by an IoT reader (e.g., a UE 115). The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between devices. For example, a lightning bolt mat indicate wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), the UE 115h (e.g., wearable device), and the IoT device 120 (e.g., a RFID sensor) may communicate through the network 100 either directly with BSs, such as the small cell BS 105f, and the macro BSs 105d and 105c, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. In some aspects, the IoT device 120 may harvest energy from an ambient environment associated with the IoT device 120. For example, the IoT device 120 may be an ambient IoT device that may harvest energy from the BS 105d or the UE 115d. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 may assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication may be in the form of radio frames. A radio frame may be divided into a plurality of subframes, for example, about 10. Each subframe may be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes may be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal may have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe may be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 may transmit synchronization signals (e.g., including a primary synchronization signal (PSS) and a secondary synchronization signal (SSS)) in the network 100 to facilitate synchronization. The BSs 105 may broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 may perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 may enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, IAB node, a relay node, a sidelink node, etc.

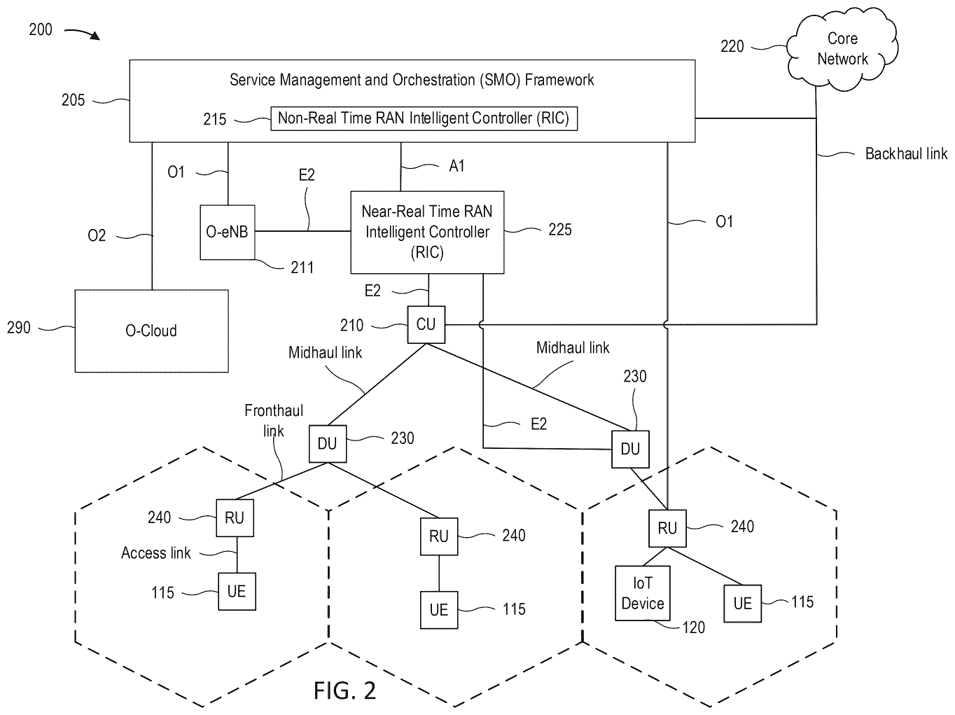

FIG. 2 shows a diagram illustrating an example disaggregated base station 200 architecture. The disaggregated base station 200 architecture may include one or more central units (CUs) 210 that may communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 (e.g., the UEs 115a-115j) and/or the IoT devices 120 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 may be logically split into one or more CU-UP units and one or more CU-CP units. The CU-UP unit may communicate bidirectionally with the CU-CP unit via an interface, such as the E1 interface when implemented in an O-RAN configuration. The CU 210 may be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) may be implemented with an interface configured to communicate signals with other layers (and modules) hosted by the DU 230, or with the control functions hosted by the CU 210.

Lower-layer functionality may be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 may be implemented to handle over the air (OTA) communication with one or more UEs 115. In some implementations, real-time and non-real-time aspects of control and user plane communication with the RU(s) 240 may be controlled by the corresponding DU 230. In some scenarios, this configuration may enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements may include CUs 210, DUs 230, RUs 240 and Near-RT RICs 225. In some implementations, the SMO Framework 205 may communicate with a hardware aspect of a 4G RAN, such as an open eNB (O-eNB) 211, via an O1 interface. Additionally, in some implementations, the SMO Framework 205 may communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

In some aspects, an ambient IoT device 120 may receive, from a first RU 240, a first signal. The ambient IoT device 120 may be powered by energy transmitted by the first RU 240. The ambient IoT device 120 may select, based on at least one of an energy conversion efficiency associated with the first signal or a communication link quality associated with the first RU 240, a second RU 240 and/or a UE 115. The ambient IoT device 120 may receive, from the second RU 240 or the UE 115, a second signal.

In some aspects, a first RU 240 may establish, with an ambient IoT device 120, a communication link. The first RU 240 may send, to the ambient IoT device 120, a first signal. The first signal may be an energy signal to power the ambient IoT device 120. The first RU 240 may select, based on at least one of an energy conversion efficiency associated with the first signal or a communication link quality associated with the ambient IoT device 120, a second RU 240 and/or a UE 115. The first RU 240 may receive, from the second RU 240 or the UE 115, a second signal.

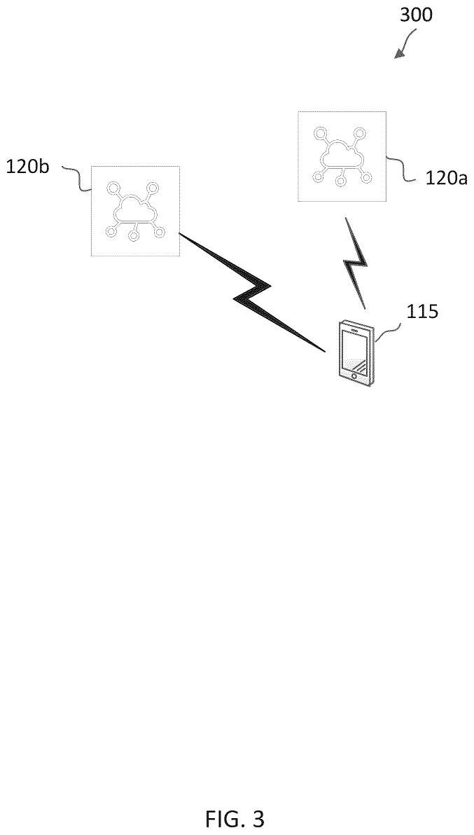

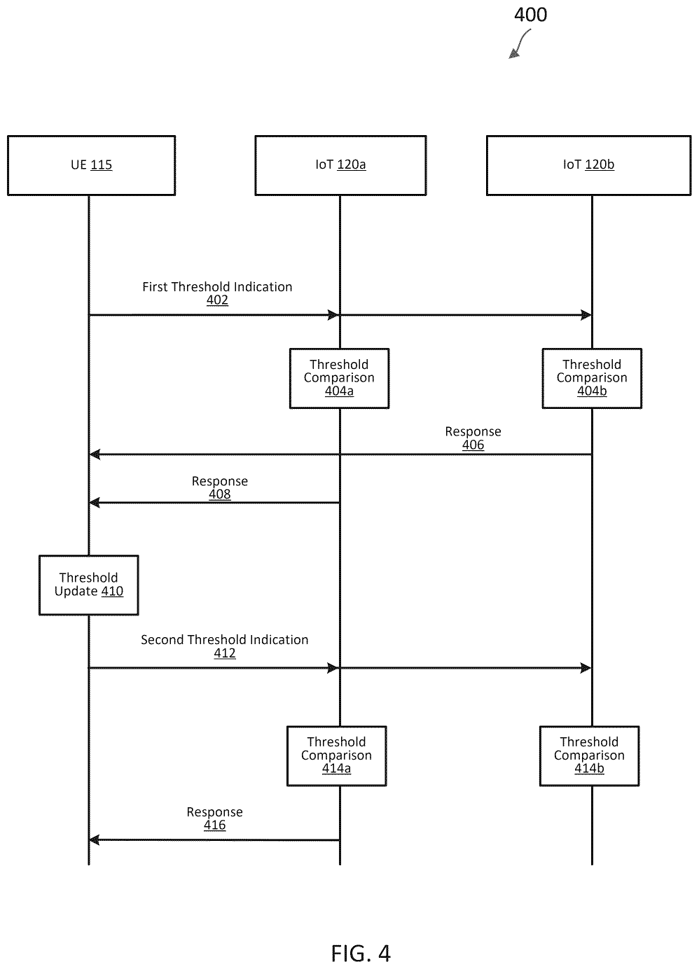

FIG. 3 illustrates an example of wireless communication between a UE 115 and ambient IoT devices 120a and 120b. In some aspects, UE 115 is an IoT reader device that is not necessarily part of a larger network such as those illustrated in FIGS. 1 and 2. UE 115 may be, for example, a handheld RFID reader device, and IoT devices 120a and 10b may be RFID tags and/or sensors. In some aspects, rather than a UE 115, the actions may be performed by a BS 105 or other network unit as described in FIGS. 1-2 that may communicate with an IoT device 120. In some aspects, the IoT devices 120a and 120b may be powered by energy transmitted by UE 115. IoT device 120a may be a different type of device than IoT device 120b, and may therefore have different properties (e.g., receiver sensitivity, transmitter power, frequency range, etc.). Communication between UE 115 and IoT devices 102a and 102b may be performed as described with respect to FIGS. 4-7.

FIG. 4 is a flow diagram of a communication method 400 according to some aspects of the present disclosure. Aspects of the method 400 may be executed by a computing device (e.g., a processor, processing circuit, and/or other suitable component) of a communication device or other suitable means for performing the actions. For example, a communication device, such as the ambient IoT device 120a or 120b or the ambient IoT device 500 may utilize one or more components, such as the processor 502, the memory 504, the selective response module 508, the transceiver 510, the modem 512, and the one or more antennas 516, to execute aspects of method 400. The method 400 may employ similar mechanisms as in the networks 100 and 200 and/or the aspects and actions described with respect to FIG. 3. For example, a communication device, such as a UE 115 may utilize one or more components, such as the processor 602, the memory 604, the IoT communication module 608, the transceiver 610, the modem 612, and the one or more antennas 616, to execute aspects of method 400. As illustrated, the method 400 includes a number of enumerated actions, but the method 400 may include additional actions before, after, and in between the enumerated actions. In some aspects, one or more of the enumerated actions may be omitted or performed in a different order.

At action 402, UE 115 broadcasts a first threshold indication to IoT devices 120a and 120b. Additional IoT devices 102 may receive the broadcast and perform the same functions as described below, and devices 120a and 120b are exemplary. The first threshold indication may be a received signal strength indicator (RSSI) value or a received power value.

At actions 404a and 404b, IoT devices 102a and 102b respectively perform a threshold comparison. The threshold comparison may be a comparison between the received power of the first threshold indication signal, and the value indicated in the first threshold indication. For example, the first threshold indication signal may be received by IoT device 120a at a certain power level (e.g., 10 in some units), and IoT device 120b may receive the first threshold indication signal at a different power level (e.g., 6 in some units) due to being further away, or having a less sensitive receiver. The value indicated in the first threshold indication may be a 5 in the same units.

At action 406, IoT device 120b transmits a response to UE 115 based on the threshold comparison at action 404b. Continuing the example above, the received power of 6 exceeds the indicated first threshold value of 5, and based on this satisfaction of the threshold, the response is transmitted by IoT device 120b.

At action 408, IoT device 120a transmits a response to UE 115 based on the threshold comparison at action 404a. Continuing the example above, the received power of 10 exceeds the indicated first threshold value of 5, and based on this satisfaction of the threshold, the response is transmitted by IoT device 120a.

At action 410, UE 115 updates the threshold value. In some aspects, UE 115 increases the threshold by a fixed amount (e.g., 2 in the same units). In some aspects, the change in value may be based on the number of IoT devices that transmitted a response to the first threshold indication, based on the received power of one or more of the responses, or other factors. In some aspects, the change in value may be adjusted each time that a change is made, for example, the threshold may begin by changing at large increments and then use progressively smaller increments as the number of devices responding approaches 1. In some aspects, if no devices respond, then the threshold value is decreased.

At action 412, UE 115 broadcasts a second threshold indication of the threshold value determined at action 410. As with the first threshold indication, the second threshold indication may be received by more or fewer IoT devices 120 than illustrated.

At actions 414a and 414b, IoT devices 102a and 102b respectively perform another threshold comparison. The threshold comparison may be a comparison between the received power of the second threshold indication signal, and the value indicated in the second threshold indication. For example, the second threshold indication signal may be received by IoT device 120a at a certain power level (e.g., 10 in some units), and IoT device 120b may receive the second threshold indication signal at a different power level (e.g., 6 in some units) due to being further away, or having a less sensitive receiver. The value indicated in the second threshold indication may be an 8 in the same units.

At action 416, IoT device 120a transmits a response to UE 115 based on the threshold comparison at action 414a. Continuing the example above, the received power of 10 exceeds the indicated second threshold value of 8, and based on this satisfaction of the threshold, the response is transmitted by IoT device 120a. Since the received power at IoT device 120b in the example is below the indicated second threshold value, it does not transmit a response. In this way, the UE 115 has identified a single IoT device (IoT device 120a), which may be the closest IoT device 120, or otherwise significant. For example, in a warehouse with boxes each having an IoT device (e.g., RFID tag), a user with a handheld reader (e.g., UE 115) may scan the closest box via method 400 even when additional boxes are within range of the reader.

In some aspects, the threshold indications are simple received power levels. In some aspects, the threshold indications are RSSI values. Measured RSSI values may be scaled by individual IoT devices 120 based on their respective receiver sensitivity. In this way, heterogenous IoT devices 120 with different receiver sensitivities may provide accurate responses that reflect incident power (e.g., based on distance from UE 115) rather than receiver sensitivity. For example, an IoT device 120b that is slightly further away from UE 115 than an IoT device 120a, but has a higher receiver sensitivity may have a measured received power that is higher than IoT device 120a, despite being further away. In order to accurately determine relative distance to the devices, RSSI values may be used that are scaled based on respective receiver sensitivity, resulting in the correct IoT device 120 responding (in this example IoT device 120a).

The actions of method 400 may repeat by continuing to update threshold values based on received responses until only one (or some predetermined number) response is received. If no response to a broadcast is received, the threshold may be adjusted in the opposite direction. In some aspects, the indicated threshold value may fluctuate in an attempt to isolate a single IoT device 120. For example, a control loop such as a proportional-integrative-derivative (PID) control may be used to adjust the threshold values to arrive at a desired number of responses. In some aspects, the response may indicate an identification (ID) of the responding IoT device 120. UE 115 may perform some subsequent action after identifying a single device. For example, the ID of the sole responding IoT device may be used by an application to track the device, display data via a user interface, automate a process, etc. In some aspects, additional communication may be performed between UE 115 and the identified IoT device. For example, additional sensor data may be read from the identified IoT device once it is isolated. UE 115 may transmit a sensor data (or other data) request to the identified IoT device. The IoT device receiving the request may transmit a response including the requested data (e.g., sensor data) to the UE 115. The received data may be used in some process, displayed via a user interface, etc.

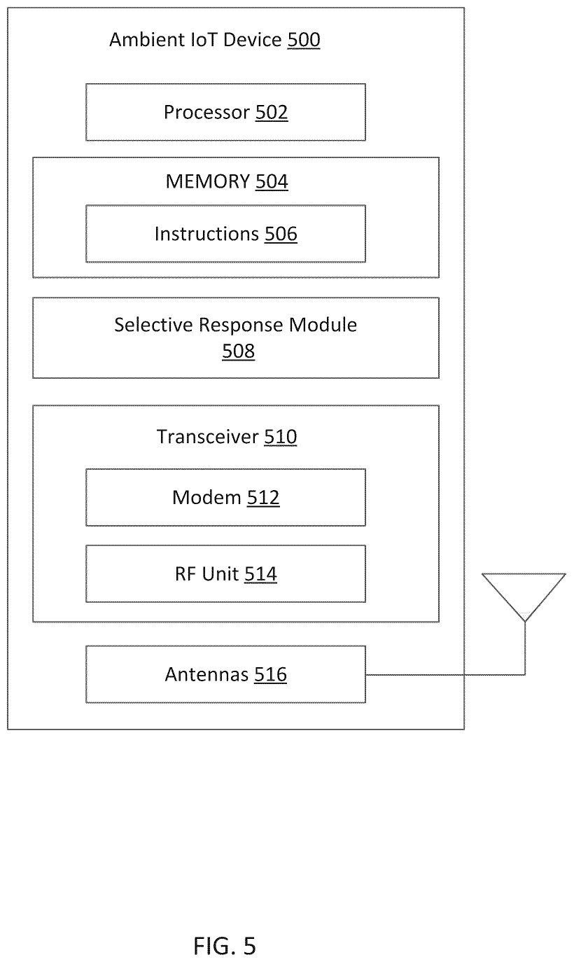

FIG. 5 is a block diagram of an exemplary ambient IoT device 500 according to some aspects of the present disclosure. The ambient IoT device 500 may be the ambient IoT device 120 in the network 100, or 200 as discussed above. As shown, the ambient IoT device 500 may include a processor 502, a memory 504, an selective response module 508, a transceiver 510 including a modem subsystem 512 and a radio frequency (RF) unit 514, and one or more antennas 516. These elements may be coupled with each other and in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 504 includes a non-transitory computer-readable medium. The memory 504 may store instructions 506. The instructions 506 may include instructions that, when executed by the processor 502, cause the processor 502 to perform the operations described herein with reference to the ambient IoT device 120 in connection with aspects of the present disclosure, for example, aspects of FIGS. 3-4. Instructions 506 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The selective response module 508 may be implemented via hardware, software, or combinations thereof. For example, the selective response module 508 may be implemented as a processor, circuit, and/or instructions 506 stored in the memory 504 and executed by the processor 502. In some aspects, the selective response module 508 may implement the aspects of FIGS. 3-4. For example, the selective response module 508 may measure a received power of a signal, compare the received power (or a value based on the received power such as RSSI) to an indicated threshold (that may be indicated via the signal) and transmit a response based on the received power satisfying the indicated threshold.

As shown, the transceiver 510 may include the modem subsystem 512 and the RF unit 514. The transceiver 510 may be configured to communicate bi-directionally with other devices, such as the BSs 105 and/or the UEs 115. The modem subsystem 512 may be configured to modulate and/or encode the data from the memory 504 and the according to a modulation and coding scheme (MCS), e.g., a low-density parity check (LDPC) coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together to enable the ambient IoT device 500 to communicate with other devices.

The RF unit 514 may provide the modulated and/or processed data, e.g., data packets (or, more generally, data messages that may contain one or more data packets and other information), to the antennas 516 for transmission to one or more other devices. The antennas 516 may further receive data messages transmitted from other devices. The antennas 516 may provide the received data messages for processing and/or demodulation at the transceiver 510. The antennas 516 may include multiple antennas of similar or different designs in order to sustain multiple transmission links. The RF unit 514 may configure the antennas 516.

In some instances, the ambient IoT device 500 may include multiple transceivers 510 implementing different RATs (e.g., NR and LTE). In some instances, the ambient IoT device 500 may include a single transceiver 510 implementing multiple RATs (e.g., NR and LTE). In some instances, the transceiver 510 may include various components, where different combinations of components may implement RATs.

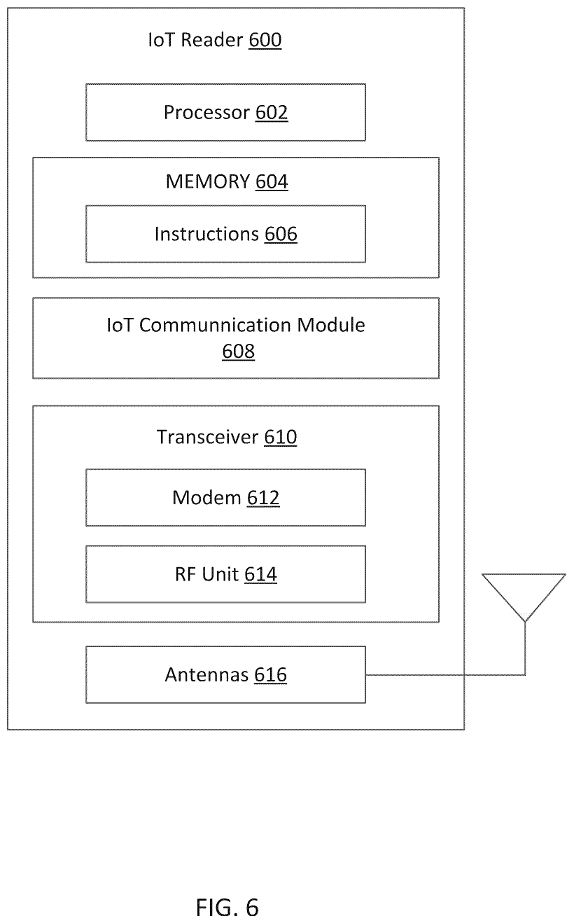

FIG. 6 is a block diagram of an exemplary IoT reader 600 according to some aspects of the present disclosure. The IoT reader 600 may be the BS 105, the CU 210, the DU 230, the RU 240, or the UE 115 as discussed above. As shown, the IoT reader 600 may include a processor 602, a memory 604, an IoT communication module 608, a transceiver 610 including a modem subsystem 612 and a RF unit 614, and one or more antennas 616. These elements may be coupled with each other and in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 3-4. Instructions 606 may also be referred to as code, which may be interpreted broadly to include any type of computer-readable statement(s).

The IoT communication module 608 may be implemented via hardware, software, or combinations thereof. For example, the IoT communication module 608 may be implemented as a processor, circuit, and/or instructions 606 stored in the memory 604 and executed by the processor 602. In some aspects, the IoT communication module 608 may implement the aspects of FIGS. 3-4. For example, the IoT communication module 608 may broadcast signals including threshold values to IoT devices, receive responses from the IoT devices, update the threshold value based on the received responses, and transmit the updated threshold value. This process may repeat until only one response is received.

Additionally or alternatively, the IoT communication module 608 may be implemented in any combination of hardware and software, and may, in some implementations, involve, for example, processor 602, memory 604, instructions 606, transceiver 610, and/or modem 612.

As shown, the transceiver 610 may include the modem subsystem 612 and the RF unit 614. The transceiver 610 may be configured to communicate bi-directionally with other devices, such as the UEs 115. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115. The RF unit 614 may be further configured to perform analog beamforming in conjunction with the digital beamforming. Although shown as integrated together in transceiver 610, the modem subsystem 612 and/or the RF unit 614 may be separate devices that are coupled together at the IoT reader 600 to enable the IoT reader 600 to communicate with other devices.

The RF unit 614 may provide the modulated and/or processed data, e.g., data packets (or, more generally, data messages that may contain one or more data packets and other information), to the antennas 616 for transmission to one or more other devices. This may include, for example, a configuration indicating a plurality of sub-slots within a slot according to aspects of the present disclosure. The antennas 616 may further receive data messages transmitted from other devices and provide the received data messages for processing and/or demodulation at the transceiver 610. The antennas 616 may include multiple antennas of similar or different designs in order to sustain multiple transmission links.

In some instances, the IoT reader 600 may include multiple transceivers 610 implementing different RATs (e.g., NR and LTE). In some instances, the IoT reader 600 may include a single transceiver 610 implementing multiple RATs (e.g., NR and LTE). In some instances, the transceiver 610 may include various components, where different combinations of components may implement RATs.

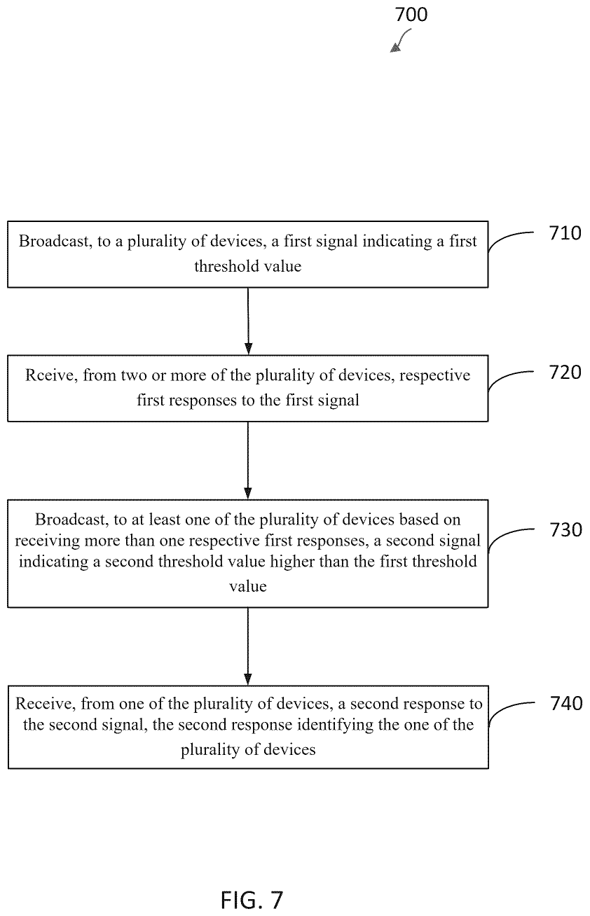

FIG. 7 is a flow diagram of a communication method 700 according to some aspects of the present disclosure. Aspects of the method 700 can be executed by a computing device (e.g., a processor, processing circuit, and/or other suitable component) of a wireless communication device or other suitable means for performing the actions. For example, a wireless communication device, such as the wireless communication device (e.g., the UE 600, the BS 105, the RU 240, the DU 230, the CU 210) may utilize one or more components, such as the processor 602, the memory 604, the IoT communication module 608, the transceiver 610, the modem 612, and the one or more antennas 616, to execute aspects of method 700. The method 700 may employ the aspects and actions described with respect to FIGS. 3-4. As illustrated, the method 700 includes a number of enumerated actions, but the method 700 may include additional actions before, after, and in between the enumerated actions. In some aspects, one or more of the enumerated actions may be omitted or performed in a different order.

At action 710, the wireless communication device broadcasts, to a plurality of devices (e.g., A-IoTs 120), a first signal indicating a first threshold value. In some aspects, the wireless communication device includes a radio frequency identification (RFID) reader, and each of the plurality of devices includes an RFID device. In some aspects, the first threshold value is a received signal strength indicator (RSSI) value. In some aspects, the first threshold value is a received power value.

At action 720, the wireless communication device receives, from two or more of the plurality of devices, respective first responses to the first signal. In some aspects, the first response may be based on the two or more of the plurality of devices measuring respective RSSI values satisfying the first threshold value. In some aspects, the first response is base on the two or more of the plurality of devices measuring respective received values satisfying the first threshold value.

At action 730, the wireless communication device broadcasts, to at least one of the plurality of devices based on receiving more than one respective first responses, a second signal indicating a second threshold value higher than the first threshold value. In some aspects, the second threshold value is higher than the first threshold value by a predetermined step amount. In some aspects, the second threshold value is higher than the first threshold value by an amount based on a quantity of respective first responses received.

At action 740, the wireless communication device receives, from one of the plurality of devices, a second response to the second signal, the second response identifying the one of the plurality of devices.

Further aspects of the present disclosure include the following:
Aspect 1. A method of wireless communication performed by a wireless communication device, the method comprising:
   broadcasting, to a plurality of devices, a first signal indicating a first threshold value;
   receiving, from two or more of the plurality of devices, respective first responses to the first signal;
   broadcasting, to at least one of the plurality of devices based on receiving more than one respective first responses, a second signal indicating a second threshold value higher than the first threshold value; and
   receiving, from one of the plurality of devices, a second response to the second signal, the second response identifying the one of the plurality of devices.
Aspect 2. The method of aspect 1, wherein:
   the wireless communication device includes a radio frequency identification (RFID) reader, and
   each of the plurality of devices includes an RFID device.
Aspect 3. The method of any of aspects 1-2, wherein the first threshold value is a received signal strength indicator (RSSI) value.
Aspect 4. The method of aspect 3, wherein the first response is based on the two or more of the plurality of devices measuring respective RSSI values satisfying the first threshold value.
Aspect 5. The method of any of aspects 1-2, wherein the first threshold value is a received power value.
Aspect 6. The method of aspect 5, wherein the first response is based on the two or more of the plurality of devices measuring respective received values satisfying the first threshold value.
Aspect 7. The method of any of aspects 1-6, wherein the second threshold value is higher than the first threshold value by a predetermined step amount.
Aspect 8. The method of any of aspects 1-6, wherein the second threshold value is higher than the first threshold value by an amount based on a quantity of respective first responses received.
Aspect 9. A method, device, apparatus, computer program product, non-transitory computer-readable medium, user equipment, base station, network entity, network node, wireless communication device, and/or processing system in accordance with one or more of aspects 1-8 and/or as described herein with reference to the accompanying detailed description and/or drawings.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations may be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A wireless communication device, comprising:
one or more memories; and
one or more processors coupled to the one or more memories, the one or more memories storing instructions that are executable by the one or more processors, configured individually or in any combination, to cause the wireless communication device to:
broadcast, to a plurality of devices, a first signal indicating a first threshold value;
receive, from two or more of the plurality of devices, respective first responses to the first signal;
broadcast, to at least one of the plurality of devices based on receiving more than one respective first responses, a second signal indicating a second threshold value higher than the first threshold value; and
receive, from one of the plurality of devices, a second response to the second signal, the second response identifying the one of the plurality of devices.

2. The wireless communication device of claim 1, wherein:
the wireless communication device includes a radio frequency identification (RFID) reader, and
each of the plurality of devices includes an RFID device.

3. The wireless communication device of claim 1, wherein the first threshold value is a received signal strength indicator (RSSI) value.

4. The wireless communication device of claim 3, wherein the first response is based on the two or more of the plurality of devices measuring respective RSSI values satisfying the first threshold value.

5. The wireless communication device of claim 1, wherein the first threshold value is a received power value.

6. The wireless communication device of claim 5, wherein the first response is based on the two or more of the plurality of devices measuring respective received values satisfying the first threshold value.

7. The wireless communication device of claim 1, wherein the second threshold value is higher than the first threshold value by a predetermined step amount.

8. The wireless communication device of claim 1, wherein the second threshold value is higher than the first threshold value by an amount based on a quantity of respective first responses received.

9. A method of wireless communication performed by a wireless communication device, the method comprising:
broadcasting, to a plurality of devices, a first signal indicating a first threshold value;
receiving, from two or more of the plurality of devices, respective first responses to the first signal;
broadcasting, to at least one of the plurality of devices based on receiving more than one respective first responses, a second signal indicating a second threshold value higher than the first threshold value; and
receiving, from one of the plurality of devices, a second response to the second signal, the second response identifying the one of the plurality of devices.

10. The method of claim 9, wherein:
the wireless communication device includes a radio frequency identification (RFID) reader, and
each of the plurality of devices includes an RFID device.

11. The method of claim 9, wherein the first threshold value is a received signal strength indicator (RSSI) value.

12. The method of claim 11, wherein the first response is based on the two or more of the plurality of devices measuring respective RSSI values satisfying the first threshold value.

13. The method of claim 9, wherein the first threshold value is a received power value.

14. The method of claim 13, wherein the first response is based on the two or more of the plurality of devices measuring respective received values satisfying the first threshold value.

15. The method of claim 9, wherein the second threshold value is higher than the first threshold value by a predetermined step amount.

16. The method of claim 9, wherein the second threshold value is higher than the first threshold value by an amount based on a quantity of respective first responses received.

17. A non-transitory computer-readable medium having program code recorded thereon for wireless communication by a wireless communication device, the program code comprising:
code for causing the wireless communication device to broadcast, to a plurality of devices, a first signal indicating a first threshold value;
code for causing the wireless communication device to receive, from two or more of the plurality of devices, respective first responses to the first signal;
code for causing the wireless communication device to broadcast, to at least one of the plurality of devices based on receiving more than one respective first responses, a second signal indicating a second threshold value higher than the first threshold value; and
code for causing the wireless communication device to receive, from one of the plurality of devices, a second response to the second signal, the second response identifying the one of the plurality of devices.

18. The non-transitory computer-readable medium of claim 17, wherein:
the wireless communication device includes a radio frequency identification (RFID) reader, and
each of the plurality of devices includes an RFID device.

19. The non-transitory computer-readable medium of claim 17, wherein the first threshold value is a received signal strength indicator (RSSI) value.

20. The non-transitory computer-readable medium of claim 19, wherein the first response is based on the two or more of the plurality of devices measuring respective RSSI values satisfying the first threshold value.
